(19) United States
(12) Patent Application Publication
(10) Pub. No.: US 2006/0073323 A1
(43) Pub. Date: Apr. 6, 2006

(54) Sound absorptive foamed plastic and production method thereof

(75) Inventors: Yoshiaki Watanabe, Tokyo (JP); Hiroyuki Kurihara, Tokyo (JP); Takanori Yumoto, Tokyo (JP); Shintaro Hara, Tokyo (JP)

Correspondence Address: ARENT FOX PLLC, 1050 CONNECTICUT AVENUE, N.W., SUITE 400, WASHINGTON, DC, 20036, US

(73) Assignee: NIHON TOKUSHU TORYO CO., LTD.

(21) Appl. No.: 11/289,301

(22) Filed: Nov. 30, 2005

Related U.S. Application Data
(62) Division of application No. 10/196,558, filed on Jul. 17, 2002.

(30) Foreign Application Priority Data
Jul. 18, 2001 (JP) 2001-217687
Jul. 18, 2001 (JP) 2001-217688
May 21, 2002 (JP) 2002-145961

(51) Int. Cl. B32B 3/26; B32B 3/00; B32B 9/00

(52) U.S. Cl. 428/304.4; 428/314.4; 428/318.4

(57) ABSTRACT

To provide a foamed plastic provided with holes having a specified area at a specified aperture ratio. The holes are either a through-hole or a non-through-hole and properly provided. The foamed plastic is superior in sound absorbing property and has a strength. In the case of non-through-holes, the foamed plastic can beep a sound absorbing effect as well as a sound intercepting effect, and for example, when used as a cushioning material of collision to be used as the lower portion of a dash panel of a motorear, not only the cushioning of collision but also the absorption of noises from an engine can be achieved. On the other hand, a foamed plastic obtained by pre-foaming foamable beads and again foaming the pre-foamed beads is a foamed plastic having gas permeability, which is different from usual foamed plastics. In this case, when an air current resistance value is set within a specified range, an audible sound of a human being can be most effectively absorbed. Thus, the latter foamed plastic can also be used as a cushioning material of collision and the like similar to the former foamed plastic.

### FIELD OF THE INVENTION

The present invention relates to foamed plastic, which is used for various uses, and the production method thereof.

### BACKGROUND OF THE INVENTION

So-called foamed plastics such as thermoplastic resin foam materials and thermosetting resin foam materials, which are used as fillers, protective materials, cushioning materials, or the like, for heat-insulated transporting of articles requiring refrigeration, storage boxes, packaging of articles, etc., have been widely used for various uses.

However, foamed plastics produced by ordinary production method do not have gas permeability and thus scarcely have a sound absorbing property.

On the other hand, a thermoplastic resin foam material is sometimes used for protecting persons in the inside of a motorcar from impact at the collision of the car by utilizing the excellent cushioning property thereof.

Also, the present applicant has filed a patent application (Japanese Patent Application No. 61664/1996) about a bulk-increasing material of a motorcar floor using a thermoplastic resin foam material as the core material.

### SUMMARY OF THE INVENTION

Accordingly, an object of the present invention is to provide a foamed plastic imparted with a sound absorbing property and a production method of the foamed plastic.

The features of the invention are as follows.

(1) A hole-having foamed plastic comprising a resin foam material, which is formed by heat-foaming, wherein holes each having a sectional area of at least 1 mm² are opened at an aperture ratio of at least 3%.

(2) The hole-having foamed plastic described in above-described feature (1), wherein the foamed plastic has holes penetrating the foam material in the thickness direction thereof.

(3) The hole-having foamed plastic described in above-described feature (1) or (2), wherein a sheet-form sound absorbing material is laminated on at least one side of the foam material.

(4) The hole-having foamed plastic described in above-described feature (1), wherein the foamed plastic is the resin foam material, which is formed by heat-forming, having holes having a sectional area of one hole of at least 1 mm² and opening at an aperture ratio of from 3% to 25% without penetrating the resin foam material.

(5) The hole-having foamed plastic described in above-described feature (4), wherein the resin foamed material has holes having a length of from 10% to 150% to the thickness of the foam material being opened without penetrating the material at one side only thereof.

(6) The hole-having foamed plastic described in above-described feature (4) or (5), wherein a sheet-form sound absorbing material is laminated on the open-hole side of the foam material.

(7) The hole-having foamed plastic described in above-described feature (4) or (5), wherein a vibration damper is laminated on the non-open-hole side of the foam material.

(8) The hole-having foamed plastic described in above-described feature (4) or (5), wherein a sheet-form sound absorbing material is laminated on the open-hole side of the foam material and a vibration damper is laminated on the non-hole-open side of the foam material.

(9) A hole-having foamed plastic having air permeability comprising a resin foam material, which is formed by heat-foaming, wherein the air current resistance value thereof after foaming is from 100 to 3000 N·S/m³.

(10) The hole-having foamed plastic having air permeability described in above-described feature (9), wherein the formed plastic has holes penetrating the foam material in the thickness direction thereof.

(11) The hole-having foamed plastic having gas permeability described in above-described feature (9) or (10), wherein a sheet-form sound absorbing material is laminated on at least one side of the foamed material.

(12) A method of producing a hole-having foamed plastic, which comprises injecting a necessary composition into a mold having rod-form projections in the inside of the mold and carrying out heat-foaming.

(13) A method of producing a hole-having foamed plastic, which comprises making holes in a formed plastic obtained by heat-foaming molding by piercing the foamed plastic with rod-form material(s).

(14) A method of producing an air-permeable plastic foam, which comprises once heating foamable beads to carry out pre-foaming until volume thereof expands from 2 to 100 times of the original volume, injecting the above-described pre-foamed beads and other necessary composition into a mold, and heat-foaming the mixture.

### BRIEF DESCRIPTION OF THE DRAWINGS

FIG. 1 is a cross-sectional view of an embodiment of the hole-having foamed plastic of the invention,

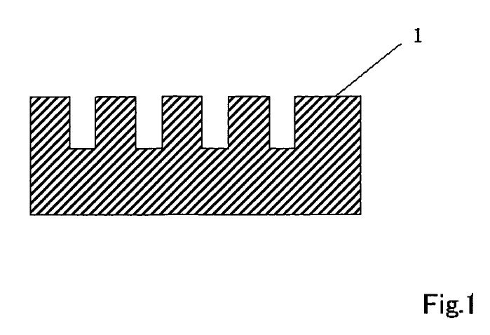

FIG. 2 is a cross-sectional view of an embodiment of the hole-having formed plastic of the invention laminated with a sheet-form sound absorbing material,

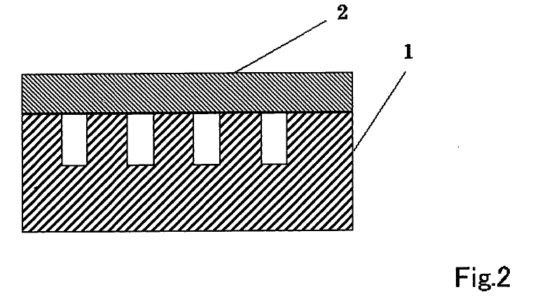

FIG. 3 is a cross-sectional view of an embodiment of the hole-having formed plastic of the invention laminated with a vibration damper, and

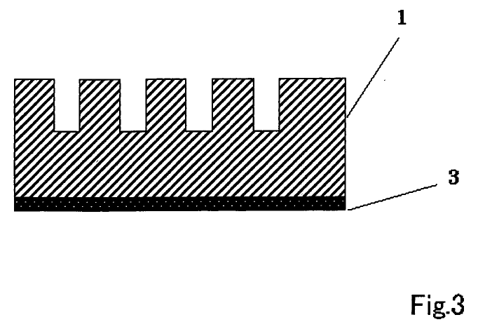

FIG. 4 is a cross-sectional view of an embodiment of the hole-having foamed plastic of the invention laminated with a sheet-form sound absorbing material and a vibration damper.

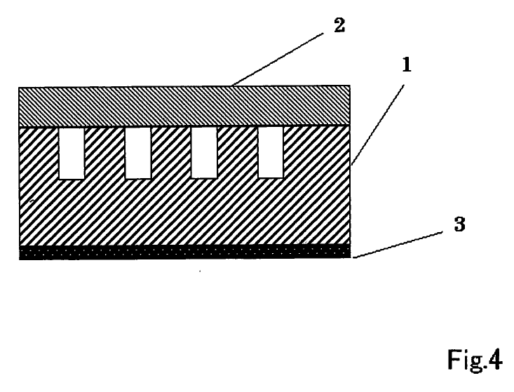

In the figures, 1 is a hole-having foamed plastic, 2 is a sheet-form sound absorbing material, and 3 is a vibration damper.

### DETAILED DESCRIPTION OF THE INVENTION

Then, the invention is explained in detail.

As the plastic used in the invention, various known raw materials such as thermoplastic resins and thermosetting resins can be used, and as the production method, a beads foaming method, an extrusion foaming method, a normal pressure foaming method, a pressure foaming method, etc., are known, and in the invention, foamed plastic obtained by any known methods can be used as the foamed plastic of the invention.

Examples of the thermoplastic resin used in the invention include polypropylene resins, polystyrene resins, polyethylene resins, vinyl chloride resins, vinyl acetate resins, and ethylene-vinyl acetate copolymer resins.

Examples of the thermosetting resin used in the invention include polyurethane resins, urea resins, phenol resins, silicone resins, and epoxy resins.

In the extrusion foaming method, a granular pellet-form resin becoming the nuclei and a foaming agent such as a low-boiling hydrocarbon, a halogen hydrocarbon, a chemical foaming agent, etc., are quantitatively weighed, the mixture is foamed by an extruding machine, a foam material foamed by the extruding machine is wound round a roll, and cut into a roll-form sheet or a definite size to form a foam material of a form of a board of a definite size, etc.

The normal pressure method is a method of obtaining a foam material through mixing and extrusion steps, and further through a radiation crosslinking step or a chemical crosslinking step.

In the pressure foaming method, a method of first forming a foaming crosslinked product by pressure crosslinking and foaming the product at normal pressure is employed.

In the beads foaming method, the 1st stage of the production method is the stage of producing foamable beads. A production method of foamable beads, which has been widely carried out at present, is a polymerization method and an impregnation method. In the polymerization method, the foamable beads are obtained by suspension polymerizing the monomer of the resin used added with mainly a saturated hydrocarbon-base foaming agent such as butane, pentane, etc., and a catalyst in a polymerization vessel. In the impregnation method, the foamable beads are obtained by pressing pellet-form or spherical resin used into a pressure pot together with a dispersing solution, and then pressing a saturated hydrocarbon-base foaming agent, such as propane, butane, etc., into the pot followed by stirring, whereby the resin is impregnated with the foaming agent in a diffused state.

Since the foamed plastics obtained by these known methods usually have no gas permeability or have scarcely gas permeability, a sound absorbing faculty is scarcely expected. Accordingly, in the present invention, the foamed plastic having holes of a sectional area of at least 1 mm² at an aperture ratio of at last 3% has been developed. It is necessary that the sectional area of one hole is at least 1 mm². When the sectional area of the hole is less than 1 mm², a necessary sound absorbing effect is not obtained. Also, when the aperture ratio is less than 3%, there is a possibility that a sufficient sound absorbing faculty is not obtained.

Particularly, in the invention, in the case of having non-penetrated holes, it is desirable that the holes have the aperture ratio of from 3 to 25%, and more preferably from 12 to 20%. In this case, it is also necessary that the sectional area of one hole is at least 1 mm². When the sectional area of the hole is less than 1 mm², a necessary sound absorbing effect is not obtained. Also, when the aperture ratio is less than 3%, there is a possibility of not obtaining a sufficient sound absorbing faculty, and when the aperture ratio exceeds 25%, there is a possibility of causing the problems that the strength of the foamed plastic is lowered, whereby the foamed plastics is liable to be cracked.

In the case of the foamed plastic described in above-described feature (1), the holes formed are not necessarily penetrated ones or may be penetrated ones. When the holes of the above-described conditions are formed in the surface of the foamed plastic, it becomes a so-called Helmholtz type sound absorbing structure to remarkably give a sound absorbing effect. Also, when penetrated holes are formed, it is more preferably to employ a construction of laminating a sheet-form sound absorbing material, and in this case, by the resonance caused in the holes and the laminated sheet-form sound absorbing material, a joint high sound absorbing effect is obtained.

In the case of the foamed plastic described in above-described feature (4), the holes opened are not penetrated and also, it is preferred that the holes are opened to one side only of the foamed plastic. The open direction of each open hole may be perpendicularly to the surface of the foamed plastic, or may slanted with an angle, or further, the cross section of the inside diameter of each open hole may be changed. By the fact that the open holes are not penetrated, it becomes possible to keep the sound intercepting effect specific to the foamed plastic without lowering the effect simultaneously with generating a sound absorbing effect by the holes.

For opening surface holes or penetrated holes in the foamed plastic, there are various methods and one of them is a method of carrying out foaming molding in a foaming mold having rod-form projection in the inside of the mold. By controlling the aperture ratio of the holes, that is, the diameter of the projections and by controlling the length of the projections, the holes formed become penetrated holes or surface holes (non-penetrated holes).

In another method of them, holes are formed in the thickness directions of the foamed plastic by an optional post-working method such as by piercing the foam material obtained after heat-foaming molding with a needle-form material or a rod-form material, holing by a drill having a screw blade, etc. In this case, by heating the needle-form materials or the rod-form materials, narrow holes can be easily formed.

In the case of the foamed plastic described in above-described feature (4), it is preferred that the foamed plastic has holes opened to one side only with a length of from 10% to 150% to the thickness of the foam material.

As described above, since it is free that the open direction of each open hole may be perpendicularly to the surface of the foamed plastic, or may slant with an angle, etc., as described above, the non-penetrated holes can be selected in the range of the length of from 10% to 150% of the thickness of the foam material. When the length of the hole is less than 10%, the sound adsorbing performance, etc., are lowered, and on the other hand, when the length exceed 150%, since the holes must be formed at a small angle, the number of the opened holes is reduced, whereby there is a possibility that the holes formed cannot satisfy the aperture ratio defined above, hence a possibility that the foamed plastic has insufficient rigidity and strength to be put to practical use.

The foamed plastic of the invention has a necessary and sufficient sound absorbing performance even in a simple substance, but by laminating a sheet-form sound absorbing material on one side or both sides thereof, a more excellent sound absorbing effect can be obtained. There is no particular restriction on the sheet-form sound absorbing material, but examples of the sound absorbing material include clothes, nonwoven fabrics, resin felts, thermoplastic felts, and needled felts.

Even in the case of the foamed plastic described in above-described feature (4), the formed plastic has a necessary and sufficient sound absorbing performance even in a simple substance, but by laminating a sheet-form sound absorbing material on one side of the open holes, a more excellent sound absorbing effect can be obtained. There is no particular restriction on the sheet-form sound absorbing material, but examples of the sound absorbing material include clothes, nonwoven fabrics, resin felts, thermoplastic felts, needled felts and various types of resin foams such as polyurethane. In addition, in case of opening holes by post-working, after laminating the above-described sheet-form sound absorbing material, the non-penetrated holes may be opened from the laminated sheet-form sound absorbing material.

Also, by laminating various kinds of vibration dampers such as an asphalt-base vibration damper, a rubber sheet-base vibration damper, a thermoplastic resin-base vibration damper, a thermosetting resin-base vibration damper, etc., on the side having no opening of the foamed plastic, simultaneously with a sound absorbing effect, a vibration damper effect can be obtained, and the synergistic sound preventing effect can be expected.

The foamed plastic having gas permeability comprising a resin foam material formed by heat-foaming, wherein the air current resistance thereof after foaming is from 100 to 3000 N·S/m³ described in above-described feature (9), can be obtained in relation to the above-described beads foaming method, which comprises once heating foamable beads to carry out pre-expanding, using the foamable beads expanded to from 2 to 100 times the original volume, injecting the above-described pre-foamed foamable beads and other necessary composition into a mold, and heat-foaming the mixture.

As the resin constituting the foamable beads, the resins same as those used for the above-described foamed plastic can be used. However, in the resins illustrated above, three kinds of resins such as polypropylene, polystyrene, and polyethylene are preferably used, and in the resins, two kinds of resins such as polypropylene and polyethylene are particularly preferably used.

In the case of obtaining the foamed plastic having gas permeability, it is necessary, as described above, to use foamable beads as a foaming agent, heating the foamable beads to carry out pre-expanding and to expand the volume to from 2 to 100 times the original volume. This step is indispensable to form gaps in the foamed plastic formed to form a so-called “a millet and rice cake form”. When the volume expansion is less than twice, the formation of gaps is insufficient and a necessary air current resistance is not obtained, and when the volume expansion exceeds 100 times, the rigidity and the strength of the foamed plastic become weak and brittle, and there is a possibility that the foamed plastic obtained cannot be use for practical purposes.

Then, the foamable beads pre-foamed by the above-described condition are placed in a mold of an optional form, and an in-mold foaming molding is carried out by a known method such as steam superheating foaming, etc., to obtain the foamed plastic. By re-foaming the foamable beads, the volumes of which have been already expanded by the pre-foaming, the beads are imperfectly fused each other and become the state of being point-fused. As the result thereof, different from an ordinary foamed plastic, the foamed plastic formed has air permeability.

The air permeability in the foamed plastic having air permeability is evaluated by the air current resistance value, and it is necessary that the value of the air permeability is from 100 to 3000 n·S/m³.

This is because the air current resistance value of the range can most effectively absorb the audible sound of a human being. The air current resistance value can be controlled to the above-described range, by controlling the volume expansion by the pre-foaming of the foamable beads, or by controlling the heating temperature and pressure conditions at the foaming. Also, when the air current resistance value of the foamed plastic exceeds 3000 N·S/m³, by opening the holes in the thickness direction of the foamed plastic by an optional post-working method such as pin-cushion working, etc., the air current resistance value can be controlled to the above-described range.

The foamed plastic having air permeability has a necessary and sufficient sound absorbing performance even in a simple substance, but by laminating a sheet-form sound absorbing material on one side or both sides thereof, a more excellent sound absorbing effect can be obtained. There is no particular restriction on the sheet-form sound absorbing material, but examples of the sound absorbing material include clothes, nonwoven fabrics, resin felts, thermoplastic felts, and needled felts.

As described above in detail, since the hole-having foamed plastic of the invention has as excellent sound absorbing property, the foamed plastic is particularly effectively used for the portions requiring sound absorbing performance simultaneously with shock cushioning and heat-insulating property. For example, by using the formed plastic for insulating material for building, in addition to the heat-insulating property, a sound absorbing performance can be imparted, whereby a pleasant space in room can be obtained, and also by using a cushioning material of collision used as the lower portion of a dash panel of a motorcar, the effect of absorbing noises from the engine room can be added, Also, by using a bulk-increasing material of a motorcar floor, the effect of reducing noises in the car room can be also obtained.

Then, for more understanding the present invention, examples are described below but, as a matter of course, the invention is not limited to the following examples.

### EXAMPLE 1

Foamable beads were made from a polystyrene monomer, the foamable beads were injected into a mold having disposed in the inside thereof many needle-form materials having a length same as the thickness of the foam formed therein and a sectional area of 5 mm², and by carrying out steam heat-foaming and drying, a polystyrene foam material of a rectangular parallelepiped having a thickness of 20 mm was obtained. In the polystyrene foam material, many penetrated holes each having a sectional area of 5 mm² were formed and the aperture ratio was 10%.

### EXAMPLE 2

Foamable beads were made from a polyethylene monomer, the foamable beads were injected into a mold and by carrying out steam heat-foaming and drying, a polyethylene foam material of a rectangular parallelepiped having a thickness of 20 mm was obtained. The foamed polyethylene foam material was pieced by a metal forming jig having many needle-form materials and heated to 200° C. to form penetrated holes each having a sectional area of 5 mm². The aperture ratio was 20%.

### EXAMPLE 3

Foamable beads were made from a polypropylene monomer, the foamable beads were injected into a mold and by carrying out steam heat-foaming and drying, a polypropylene foam material of a rectangular parallelepiped having a thickness of 20 mm was obtained. The polypropylene foam material was pieced by a metal forming jig having many needle-form materials and heated to 200° C. to form penetrated holes each having a sectional area of 5 mm². The aperture ratio was 20%. On the form material was laminated a sheet-form sound absorbing material made of a resin felt having a thickness of 20 mm.

### COMPARATIVE EXAMPLE 1

Foamable beads were made from a polystyrene monomer, the foamable beads were injected into a mold and by carrying out steam heat-foaming and drying, a polystyrene foam material of a rectangular parallelepiped having a thickness of 20 mm was obtained.

Test Method 1:

About the foamed materials of Examples 1 to 3 and Comparative Example 1, the acoustic absorption coefficients at specific frequencies were measured by the measurement method of acoustic absorption coefficient by the reverberation room method regulated by JIS A 1406.

Results

The acoustic absorption coefficients of Examples 1 to 3 and Comparative Example 1 were as follows. (Unit: %)

Frequencies (Hz)

| | 500 | 1000 | 2000 | 4000 |
|---|---|---|---|---|
| Examp1e 1 | 7.8 | 22.5 | 71.2 | 31.0 |
| Examp1e 2 | 11.5 | 30.5 | 68.0 | 30.0 |
| Example 3 | 60.0 | 84.0 | 60.0 | 23.0 |
| Comp. Ex. 1 | 5.5 | 15.0 | 36.0 | 23.0 |

As shown in the above results, in the hole-having foamed materials of Examples 1 to 3, in each case, in the frequency regions of the acoustic range, the improvements of the acoustic absorption coefficient of 2 dB at the minimum to 70 dB at the maximum were observed as compared with the resin foamed material of Comparative Example 1.

### EXAMPLE 4

Foamable beads were made from a polystyrene monomer, the foamable beads were injected into a mold having disposed in the inside thereof many needle-form materials having a length of from 10 to 17 mm and a sectional area of 20 mm², and by carrying out steam heat-foaming and drying, a polystyrene foam material of a rectangular parallelepiped having a thickness of 30 mm was obtained. In the foamed polystyrene form material, many non-penetrated holes each having a sectional area of 20 mm² opened to one side were formed and the aperture ratio of the holes at the open side was 12%.

### EXAMPLE 5

Foamable beads were made from a polyethylene monomer, the foamable beads were injected into a mold and by carrying out steam heat-foaming and drying, a polyethylene foam material of a rectangular parallelepiped having a thickness of 30 mm was obtained. The polyethylene foam material was pieced by a metal forming jig having many needle-form materials and heated to 200° C. to form non-penetrated holes each having a sectional area of 30 mm² and opening to one side only. The aperture ratio of the open-hole side was 20%.

### EXAMPLE 6

Foamable beads were made from a polypropylene monomer, the foamable beads were injected into a mold and by carrying out steam heat-foaming and drying, a polypropylene foam material of a rectangular parallelepiped having a thickness of 30 mm was obtained. The polypropylene foam material was pieced by a metal forming jig having many needle-form materials and heated to 200° C. to form non-penetrated holes each having a sectional area of 20 mm² and opening to one side only. The aperture ratio of the open-hole side was 13%. On the side having opening of the formed material was laminated a sheet-form sound absorbing material made of resin felt of a thickness of 20 mm.

### EXAMPLE 7

Foamable beads were made from a polypropylene monomer, the foamable beads were injected into a mold and by carrying out steam heat-foaming and drying, a polypropylene foam material of a rectangular parallelepiped having a thickness of 30 mm was obtained. In the polypropylene foam material, non-penetrated holes each having a sectional area of 20 mm² and opening to one side only were formed by a drill having a spiral blade. The aperture ratio of open-hole side was 13%. On the side having no opening of the formed material was laminated an asphalt-base vibration damper sheet having a thickness of 3 mm.

### EXAMPLE 8

Foamable beads were made from a polypropylene monomer, the foamable beads were injected into a mold in which a rubber sheet having a thickness of 2 mm was previously laminated and by carrying out steam heat-foaming and drying, a polypropylene foam material of a rectangular parallelepiped having a thickness of 30 mm and having laminated thereon a rubber sheet having a thickness of 2 mm was obtained. On the foamed polypropylene foam material was laminated a needled felt having a thickness of 5 mm, and from the surface of the needled felt, non-penetrated holes each having a sectional area of 20 mm² opening to one side only were formed by a drill having a spiral blade. The aperture ratio of the open-hole side was 13%.

### COMPARATIVE EXAMPLE 2

Foamable beads were made from a polystyrene monomer, the foamable beads were injected into a mold and by carrying out steam heat-foaming and drying, a polystyrene foam material of a rectangular parallelepiped having a thickness of 30 mm was obtained.

### REFERENCE EXAMPLE

In the same polystyrene form material as in Comparative Example 2, penetrated holes having a sectional area of one hole of 20 mm² were formed at an aperture ratio of 20%.

Test Method 2:

About each of the foamed materials of Examples 4 to 8, Comparative Example 2 and Reference Example, the absorption coefficients at specific frequencies were measured by “the measurement method of acoustic absorption coefficient by the reverberation room method” regulated by JIS A 1406.

Test Method 3:

About each of the foamed materials of Examples 4 to 8, Comparative Example 2 and Reference Example, the sound insulation effect at specific frequencies was measured by “the sound transmission loss measurement method in laboratory” regulated by JIS A 1416.

Results

The sound absorbing ratios of Examples 4 to 8, etc., are shown in Table 1 below. The unit is %.

TABLE 1

Frequency (Hz)

| | 500 | 1000 | 2000 | 4000 |
|---|---|---|---|---|
| Example 4 | 7.5 | 24.5 | 73.0 | 31.0 |
| Example 5 | 11.5 | 30.5 | 68.0 | 30.0 |
| Example 6 | 40.0 | 90.0 | 85.0 | 90.0 |
| Example 7 | 12.0 | 29.5 | 70.0 | 35.0 |
| Example 8 | 20.0 | 35.0 | 76.0 | 45.0 |
| Ref. Example | 55.0 | 16.0 | 10.0 | 8.0 |
| Com. Example 2 | 6.0 | 21.0 | 70.0 | 30.0 |

Ref.: Reference
Com.: Comparative

Also, the sound insulation effects of Examples 4 to 8, etc., are shown in Table 2 below. The unit is dB.

TABLE 2

Frequency (Hz)

| | 500 | 1000 | 2000 | 4000 |
|---|---|---|---|---|
| Example 4 | 4.8 | 5.3 | 9.5 | 18.0 |
| Example 5 | 4.5 | 5.5 | 9.0 | 18.0 |
| Example 6 | 5.2 | 10.0 | 21.0 | 89.0 |
| Example 7 | 12.0 | 5.9 | 10.0 | 25.0 |
| Example 8 | 14.0 | 8.0 | 16.0 | 42.0 |
| Ref. Example | 5.1 | 6.0 | 10.0 | 19.0 |
| Com. Example 2 | 3.2 | 4.1 | 9.0 | 17.0 |

As shown in the above results, in each of the hole-having foamed materials of Examples 4 to 8, in the frequency regions of the acoustic range, the improvements of the acoustic absorption coefficient of 3% at the minimum to 80% at the maximum were observed as compared with the resin formed material of Comparative Example 2, and also the same or more improvements were observed as compared with the resin foamed material having penetrated hole in the reference example. On the other hand, in each of the hole-having foamed materials of Examples 4 to 8, in the frequency regions of the acoustic range, the improvements of the sound insulating effect of about 20 dB at the maximum were observed as compared with the resin foamed material of Comparative Example 2, and also the same or more sound insulating effects were observed as compared with the resin formed material of the reference example.

### EXAMPLE 9

Foamable beads were prepared from a polypropylene monomer by s suspension method, and the foamable beans were subjected to pre-foaming by heating at 100° C. to obtain foamable beads expanded to 50 times the average volume of the beads. The pre-foamed foamable beads were injected into a mold and by carrying out steam heat-foaming and drying steps, a polypropylene foam material of a rectangular parallelepiped having a thickness of 20 mm was obtained. The air current resistance value of the foamed polypropylene foam material was 500 N·S/m³.

### EXAMPLE 10

Foamable beads were prepared from a polyethylene monomer by s suspension method, and the foamable beans were subjected to pre-foaming by heating at 100° C. to obtain foamable beans expanded to 50 times the average volume of the beads. The pre-foamed foamable beads were injected into a mold and by carrying out steam heat-foaming and drying steps, a polyethylene foam material of a rectangular parallelepiped having a thickness of 20 mm was obtained. The air current resistance value of the foamed polyethylene foam material was 600 N·S/m³.

### EXAMPLE 11

Foamable beads were prepared from a polystyrene monomer by s suspension method, and the foamable beans were subjected to pre-foaming by heating at 100° C. to obtain foamable beans expanded to 50 times the average volume of the beads. The pre-foamed foamable beads were injected into a mold and by carrying out steam heat-foaming and drying steps, a polystyrene foam material of a rectangular parallelepiped having a thickness of 20 mm was obtained. The air current resistance value of the foamed polystyrene foam material was 800 N·S/m³, but as the result of applying needle working to the thickness direction to form penetrated holes, the air current resistance value became 200 N·S/m³.

### COMPARATIVE EXAMPLE 1

Foamable beads were formed from a polystyrene monomer, the foamable beads were injected into a mold and by carrying out steam heat-foaming and drying, a foamed polystyrene foam material of a rectangular parallelepiped having a thickness of 20 mm was obtained.

Test Method 1:

About the foamed materials of Examples 9 to 11 and Comparative Example 1, the acoustic absorption coefficients at specific frequencies were measured by “the measurement method of acoustic absorption coefficient by the reverberation room method” regulated by JIS A 1406.

Results

The acoustic absorption coefficients of Examples 9 to 11 and Comparative Example 1 were as follows. The unit was %

Frequencies (Hz)

| | 500 | 1000 | 2000 | 4000 |
|---|---|---|---|---|
| Example 9 | 9.8 | 24.7 | 70.2 | 31.0 |
| Example 10 | 12.6 | 33.0 | 62.0 | 32.0 |
| Example 11 | 60.0 | 84.0 | 60.0 | 23.0 |
| Comp. Ex. 1 | 5.5 | 15.0 | 36.0 | 23.0 |

As shown in the above results, in each of the hole-having foamed materials of Examples 9 to 11, in the frequency regions of the acoustic range, the improvements of the acoustic absorption coefficient of 2 dB at the minimum to 70 dB at the maximum were observed as compared with the resin foamed material of Comparative Example 1.

As described above, the foamed plastic of the invention shows both the shock cushioning property or heat-insulating property and the sound absorbing property which have not be obtained by foamed plastics of related art, and further shows the soundproof performance having both the sound absorbing effect and the sound intercepting effect, which can be said to various kinds of soundproof materials of motorcars as well as for various industrial fields such as, for example, building industries, etc., are expected.

1-8. (canceled)

9. A hole-having foamed plastic having air permeability comprising a resin foam material, which is formed by heat-foaming, wherein the air current resistance value thereof after foaming is from 100 to 3000 N·S/m³.

10. The hole-having foamed plastic according to claim 9, wherein the formed plastic has holes penetrating the foam material in the thickness direction thereof.

11. The hole-having foamed plastic according to claim 9 or 10, wherein a sheet-form sound absorbing material is laminated on at least one side of the foamed material.

12-14. (canceled)
